(19) United States
(12) Patent Application Publication
(10) Pub. No.: US 2024/0183341 A1
(43) Pub. Date: Jun. 6, 2024

(54) GRAVITY MOTOR AND ENERGY STORAGE DEVICE

(71) Applicant: Anthony Roach, Ozark, MO (US)

(72) Inventor: Anthony Roach, Ozark, MO (US)

(21) Appl. No.: 18/485,256

(22) Filed: Oct. 11, 2023

Related U.S. Application Data
(60) Provisional application No. 63/475,691, filed on Dec. 6, 2022.

(51) Int. Cl. F03G 3/00

(52) U.S. Cl. CPC F03G 3/094; F05B 2260/4021; F05B 2260/421; F05B 2270/101

(57) ABSTRACT

According to an aspect of the present invention, there is provided a clean energy fuel free gravity force driven motor device, comprising: a drive axle; a belt; a pulley system; weighted wheeled trolley; a guide rail; a torsion spring arm; a solid leverage arm/bracket system; a spring arm leverage housing; and a vertical plane housing; wherein the weighted wheeled trolley is directed in an alternating centripetal and centrifugal pattern by way of guided track, rail, or solid arm bracket and utilizing known leverage principles to shift a net gravitational force that creates rotational torque delivery to the drive axle.

### BACKGROUND

Significant advances have been made in alternative energy systems as society seeks to ameliorate the deleterious effects inherent in legacy energy fossil fuel systems relying on the combustion of hydrocarbons. Among the advances are in alternative energy relying on an energy storage system to capture the excess energy and deliver it when required. A typical alternative energy system will generate electrical energy. For example, solar photovoltaic cells, wind generators, tidal and wave generators will use batteries and a battery charging system to store excess electrical energy.

Thus, solutions have been proposed for storing excess electrical energy using gravitational energy. US 20160084236 describes a Gravity Field Energy Storage & Recovery System invention, which is a mechanical, electrical and electronic system that has the ability to harness any electrical or mechanical power source and allow it to do work to configure a mechanical system into a state of high potential energy, using either a hi-mass object in a gravitational field. The charging cycle consists of repositioning a massive object in a gravity field to a position of higher potential energy. The potential energy can be stored without loss for extended periods of time. The potential energy stored in the invention can be recovered on demand. The energy recovery mode consists of releasing the massive object in the gravity field in a controlled fall, producing a kinetic energy which can then be transformed into a useable form of energy such as electricity, pneumatic, or hydraulic power.

U.S. Pat. No. 3,857,242 discloses motor operating under the principles of both gravity and buoyancy comprises a vertically disposed conveyor having brackets thereon for the reception of hollow, closed tanks moved onto each bracket from the upper portion of the conveyor. As the tanks fall under their own weight, the conveyor rotates a power output shaft connected thereto. Each tank is moved off their brackets when reaching a lower portion of the conveyor, after which they are each moved into the bottom of a liquid filled receptacle having a vertically disposed conveyor located therein. The tanks are directed beneath brackets on this conveyor and, as the tanks are buoyed upwardly by the liquid, the conveyor rotates another power output shaft connected thereto. Both power output shafts may be interconnected for combining the total power output of both the gravity and buoyancy portions of the motor.

Nonetheless, prior art methods and systems for gravitational motors and energy storage devices are overly complicated and prone to failure. Improved methods and systems are desirable.

### SUMMARY OF INVENTION

Therefore, the present invention provides a motor and energy storage device utilizing gravitational force.

According to an aspect of the present invention, there is provided a clean energy fuel free gravity force driven motor device, comprising: a drive axle; a belt; a pulley system; weighted wheeled trolley; a guide rail; a torsion spring arm; a solid leverage arm bracket system; a spring arm leverage housing; and a vertical plane housing; wherein the weighted wheeled trolley is directed in an alternating centripetal and centrifugal pattern by way of guided track, rail, or solid arm bracket and utilizing known leverage principles to shift a net gravitational force that creates rotational torque delivery to the drive axle.

According to another aspect of the present invention, a gravitational energy storage device, comprising: a drive axle; a belt; a pulley system; a weighted wheeled trolley; a guide rail; a torsion spring arm; a solid leverage arm bracket system; a spring arm leverage housing; and a vertical plane housing; wherein the weighted wheeled trolley is directed in an alternating centripetal and centrifugal pattern by way of guided track, rail, or solid arm bracket and utilizing known leverage principles to shift a net gravitational force that creates rotational torque.

### BRIEF DESCRIPTION OF THE DRAWINGS

FIG. 1 illustrates a cutaway view of complete machine unit in a stackable metal housing cabinet.

FIG. 2 illustrates a single drive assembly unit, where multiple drive assembly units will be interconnected on a common drive shaft assembly.

FIG. 3 illustrates an alternate flex arm plus trolly drive assembly.

FIG. 4 illustrates a multi sectional metal machine cabinet.

FIG. 5 illustrates options for connecting four or more complete machine units in series.

FIG. 5A illustrates a gear drive-planetary output system.

FIG. 5B illustrates an alternate multiple belt and pulley system.

FIG. 5C illustrates a belt-flywheel drive output system.

### DETAILED DESCRIPTION

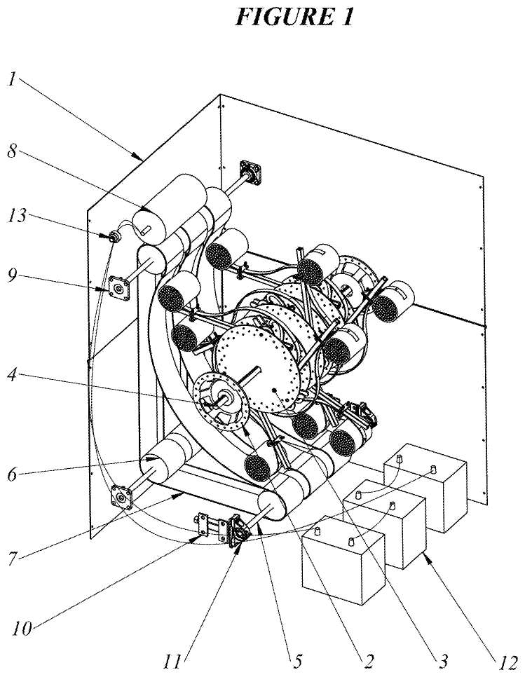

FIG. 1 illustrates a cutaway view of complete machine unit in a stackable metal housing cabinet.
item 1: Multi sectional quick assembly metal machine cabinet housing designed for interlocking stack, and for flat pack for simple handling and transport.
item 2: Flange mount bearing assembly for main drive shaft carriage.
item 3: Drive assembly hub for solid arm linkage design.
item 4: Bi-directional main drive shaft extending to the front or rear of cabinet allows for end-to-end connections of multi machine unit-series configurations.
item 5: Common belt pulley shaft.
item 6: Pulley sheave for belt handling.
item 7: Belt system for speed control and for arm swing deflection limit control.
item 8: Electronic variable speed control motor for belt drive assembly.
item 9: Flange mount bearing assembly for end mount of pulley assembly shaft carriage.
item 10: Adjustable idler tensioner bracket.
item 11: Pillow block bearing assembly for tensioner shaft carriage.
item 12: Battery pack energy storage system.
item 13: Electronic motor control switch.

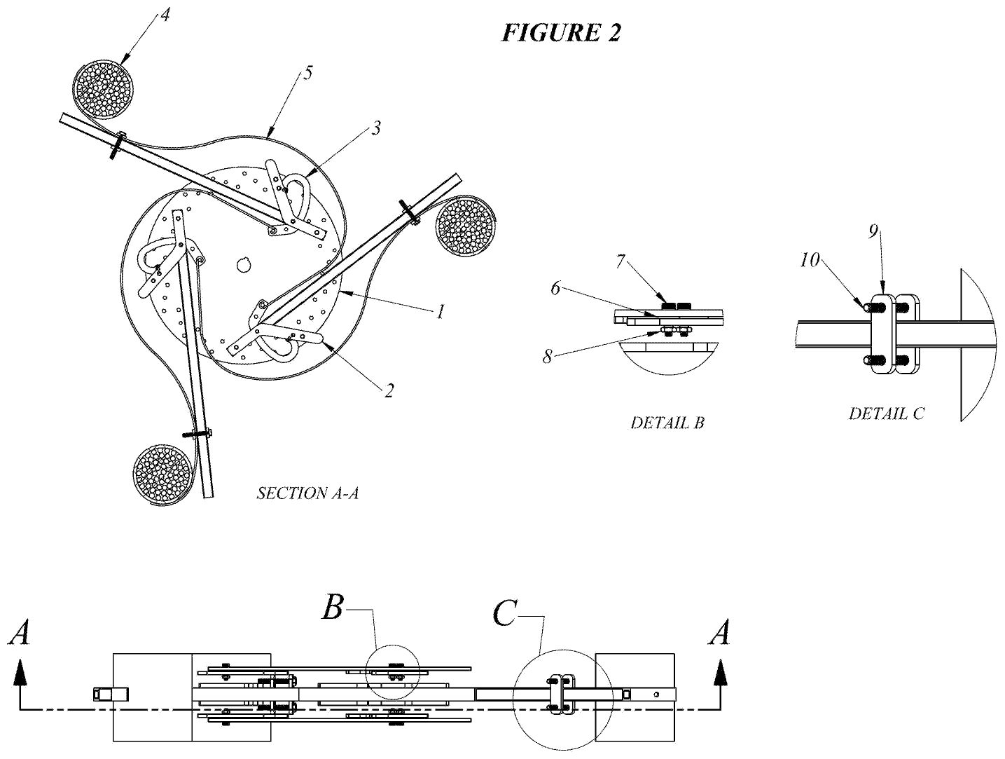

FIG. 2 illustrates a single drive assembly unit, where multiple drive assembly units will be interconnected on a common drive shaft assembly.
item 1: Drive assembly hub—also noted as item 3 in FIG. 1.
item 2: Solid arm bracket mount assembly.
item 3: Swivel mount leaf spring linkage bracket.
item 4: Cylindrical housing for unit of mass attachment to solid arm leaf spring assembly.
item 5: Leaf spring-potential energy storage device.

### Detail B

item 6: Thrust washer.
item 7: Linkage fixture bolt.
item 8: Linkage fixture nut.

### Detail C

item 9: Alignment strap fixture for leaf spring assembly.
item 10: Alignment strap bolt fixture for leaf spring assembly.

### Section A-A

Vertical cross section view representing single drive assembly.

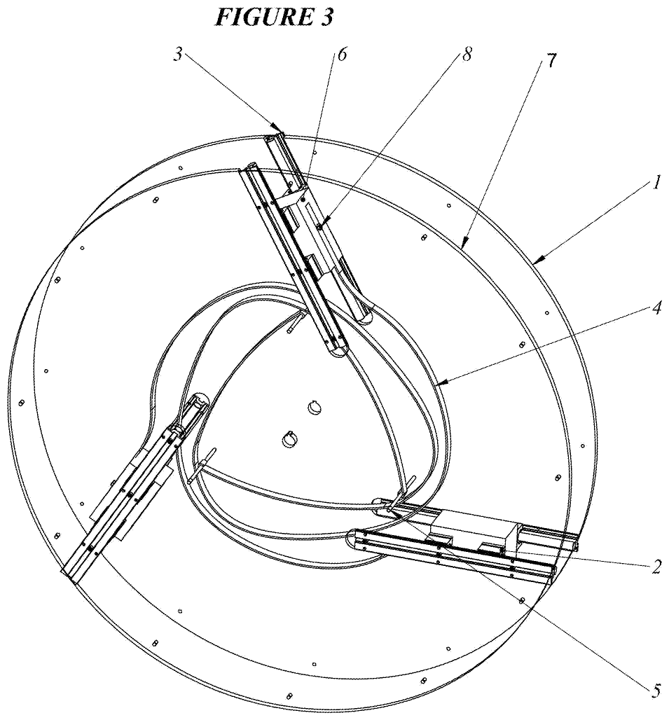

FIG. 3 illustrates an alternate flex arm plus trolly drive assembly.
item 1: Drive assembly hub.
item 2: Pillow block bearing mount.
item 3: Rail glide track mount assembly.
item 4: Leaf spring-potential energy storage fixture.
item 5: Leaf spring end mount linkage bolt.
item 6: Trolley mass
item 7: Mirror reverse drive assembly hub.
item 8: Bolt-Leaf spring end to trolly mass.

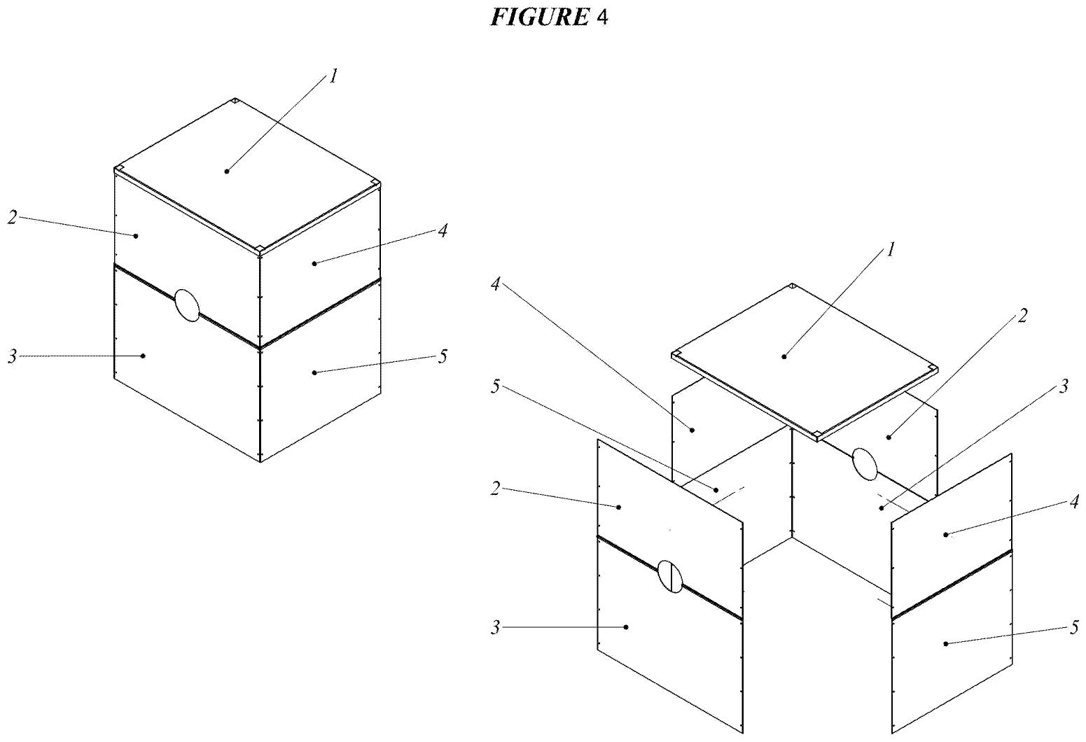

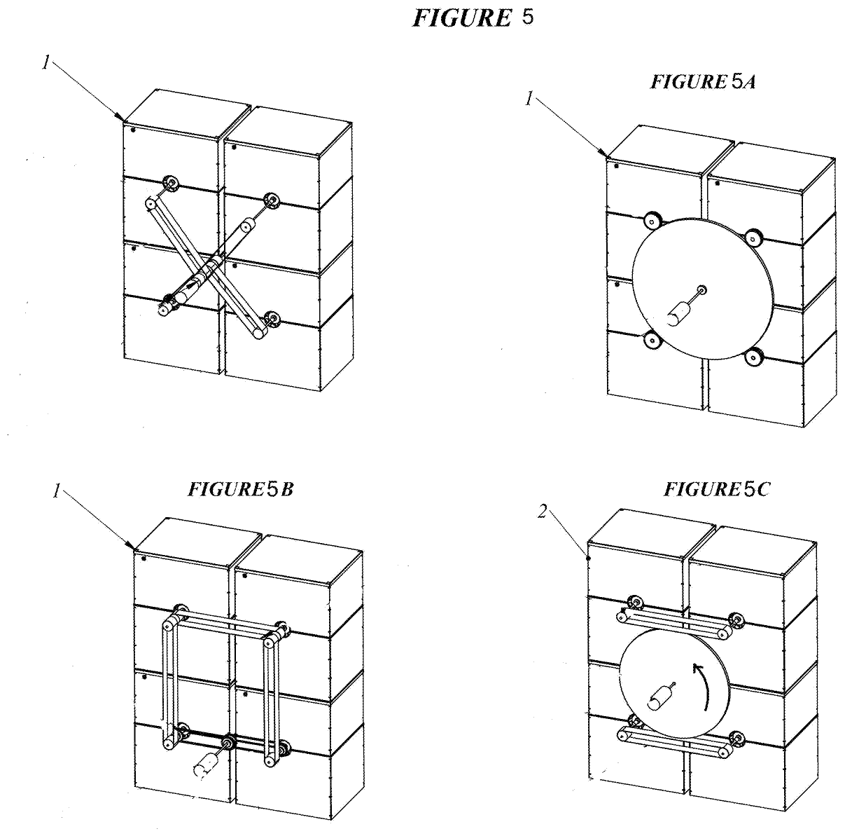

FIG. 4 illustrates a multi sectional metal machine cabinet.
item 1: Machine cabinet top with recessed corner pockets designed to receive matching adjustable feet of additional stacked machine cabinet units when connected in multiple unit series. as shown in FIG. 5.
item 2: Upper-front and rear section of machine cabinet.
item 3: Lower-front and rear section of machine cabinet.
item 4: Upper-left and right end section of machine cabinet.
item 5: Lower-left and right end section of machine cabinet.

FIG. 5 illustrates options for connecting four or more complete machine units in series.
Item 1: Depicting a complete machine unit with orientation for clockwise drive rotation.
Item 2: Depicting a complete machine unit with orientation for counterclockwise drive rotation

FIG. 5A illustrates a gear drive-planetary output system.
Item 1: Depicting a complete machine unit with orientation for clockwise drive rotation.

FIG. 5B illustrates an alternate multiple belt and pulley system.
Item 1: Depicting a complete machine unit with orientation for clockwise drive rotation.

FIG. 5C illustrates a belt-flywheel drive output system.
Item 2: Depicting a complete machine unit with orientation for counterclockwise drive rotation

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description. Therefore, it is intended that the disclosure not be limited to the particular embodiment(s) disclosed.

What is claimed is:

1. A clean energy fuel free gravity force driven motor device, comprising:
a drive axle,
a belt;
a pulley system;
a weighted wheeled trolley;
a guide rail;
a torsion spring arm;
a solid leverage arm bracket system
a spring arm leverage housing; and
a vertical plane housing;
wherein the weighted wheeled trolley is directed in an alternating centripetal and centrifugal pattern by way of guided track, rail, or solid arm bracket and utilizing known leverage principles to shift a net gravitational force that creates rotational torque delivery to the drive axle.

2. The device of claim 1, further comprising an electronic variable speed controller.

3. The device of claim 2, wherein the electronic variable speed controller is applied to the belt/pulley system.

4. The device of claim 1, further comprising one or more additional belts, pulley systems, weighted wheeled trolleys, and solid and/or flexible leverage arms/brackets, guide rails/tracks.

5. A method of producing and delivering storing gravitational elastic strain energy, comprising:
providing a drive axle,
providing a belt;
providing a pulley system;
providing a weighted wheeled trolley;
providing a guide rail;
providing a torsion spring arm;
providing a solid leverage arm bracket system
providing a spring arm leverage housing; and
providing a vertical plane housing;
linking the weighted wheeled trolly or solid leverage arm/bracket to the drive axle via the torsion spring arm; and
directing the weighted wheeled trolley along the guide rail in an alternating centripetal and centrifugal pattern to shift a net gravitational force that creates rotational torque delivery to the drive axle.

6. The method of claim 5, further comprising:
providing one or more additional belts, pulley systems, solid arm/bracket, weighted wheeled trolleys, and guide rails;
linking the additional weighted wheeled trolly(s) to the drive axle via the torsion spring arm; and
directing the additional weighted wheeled trolley(s) or solid arm/brackets along the guide rail(s) in an alternating centripetal and centrifugal pattern to shift a net gravitational force that creates rotational torque delivery to the drive axle.

7. The method of claim 5, further comprising providing an electronic variable speed motor.

8. A method of outputting stored gravity force driven elastic strain gravitational energy from the device described in claim 1, comprising:
providing a central axle output drive shaft turbine;
connecting the drive axle to direct input electric generator/motor or to parallel, sequential, or otherwise series connected power drive units the turbine;
delivering rotational torque from the drive axle to the shaft coupled device turbine.

9. A gravitational energy storage device, comprising:
a drive axle,
a belt;
a pulley system;
weighted wheeled trolley;
a guide rail;
a torsion spring arm;
a solid leverage arm/bracket system
a spring arm leverage housing; and
a vertical plane housing;
wherein the weighted wheeled trolley is directed in an alternating centripetal and centrifugal pattern by way of guided track, rail, or solid arm bracket and utilizing known leverage principles to shift a net gravitational force that creates rotational torque.
